(19) United States
(12) Patent Application Publication
(10) Pub. No.: US 2005/0137922 A1
(43) Pub. Date: Jun. 23, 2005

(54) Call center process

(75) Inventors: Geraldine Blackwood, Mableton, GA (US); Leslie S. Mercier, Woodstock, GA (US); Elizabeth Pyatt, Richmond Hill (CA); Richard J. Vazzana, Ridgefield, CT (US); Gail D. Warren, Bloomfield Hills, MI (US); Olivette M. Whipple, Flower Mount, TX (US)

Correspondence Address: IBM Corporation;IP Law Dept. IQ0A, Bld 40-3, 1701 North Street, Endicott, NY, 13760, US

(73) Assignee: International Business Machines Corporation, Armonk, NY (US)

(21) Appl. No.: 10/739,564

(22) Filed: Dec. 18, 2003

(51) Int. Cl. G06F 17/60

(52) U.S. Cl. 705/8

(57) ABSTRACT

A call center provides content on web sites for customer self-service. During a call to the call center, transaction data is captured in a knowledgebase tool. Periodically, a gap analysis is performed on the captured data to determine why the customer did not use self-service. Customer surveys including a value management survey are gathered. The gap analysis and surveys are provided to web content owners to create improved content. Subsequent transaction data is analyzed to measure improvements in customer satisfaction and use of self-service web sites.

### TECHNICAL FIELD

This invention relates generally to methods and systems for operating a call center, and specifically to reducing the cost of call center operation. More specifically the invention provides incentives for self-help thereby reducing the number of calls received.

### BACKGROUND OF THE INVENTION

Call centers are widely used to provide services to customers and other callers. Call centers have become a main contact point in dealing with customers. Because of improvements in telecommunication technologies and computer networking, call centers can now be positioned at any geographical location and operated around the clock. Hundreds of thousands of call center agents provide customers with product and service information in response to inquiries, accept orders, handle problems, and provide customer service and support throughout the world. Agents are also referred to as representatives. The term call center shall be taken herein to include centers which receive contact via telephone as well as via newer technologies including, but not limited to e-mail, live assistance, text chat, or any other contact methods known in the art and combinations thereof. Call center using such newer technologies are sometimes also referred to as contact centers.

Customer's expectations of the services available from companies have also risen. Today's customers demand friendly service from agents who are knowledgeable, capable, and accept responsibility, without having to be placed on hold for long periods of time. Despite the growth of on-line e-business capability, many customers require use of a call center to clarify information, close a sale, correct an error, or make an inquiry that is not addressed on a web site.

As a consequence, companies are spending an enormous amount on establishing, staffing, and operating call centers. For competitive reasons, each company is driven to minimize this expense without impacting and hopefully improving the services provided. For example, labor costs may be reduced by locating a call center in a remote low-wage country. Other methods of call center cost reduction have been developed.

Bateman et al. in U.S. Pat. No. 5,884,032 describe integrating live call center agents with world wide web (WWW) servers. Callers with computer equipment can access information from a company database. A two-way telephone voice connectivity may be established between a customer and an agent while sharing common screens of information. The call center agent can provide voice web navigational assistance to the customer.

Author David M. Rappaport describes in his article “The Next Wave in Do-It-Yourself Customer Service,” Business Communication Review, June 1998, pages 37-42, the cost differences between an average of $20 to $25 for a call with a live agent versus a self-service cost of $3 to $5. Self-service may employ interactive voice response technology, or touchtone routing of calls. Rappaport also describes how a company can use WWW services to provide a more versatile interface than a touchtone telephone thereby enabling more callers to perform self-service. Computer-Telephony Integration (CTI) also provides self-service while also permitting a customer to place a telephone or IP telephony call to an agent, when necessary, by clicking on a button on a web page.

Drury and Van Doren describe further extensions to CTI technology in their article “Realistic Choices for Web-Based Call Centers,” Business Communications Review, June 1999, pages 56-61. Email, Interactive Text Chat, Callbacks, and Simultaneous Web and Voice—Voice Over Internet Protocol (VOIP) capabilities can be combined with each other and CTI to provide various levels of service. Call center managers may also provide different levels of service to different customers, or a larger spectrum of services to more important customers.

Cleveland and Minnucci describe how to manage the transition from a conventional call center to an e-commerce business in their article “Developing the E-Enabled Call Center: A Strategic Perspective,” Business Communications Review, June 2000, pages 44-46, 48-50. This report mentions the need to encourage customers to use automated support alternatives, including a need to improve WWW services and interactive voice response (IVR) based self-service systems.

At the present time there remains a need to further reduce rapidly growing call center costs without decreasing customer satisfaction or response to rising customer expectations. It is believed that a system for improving WWW or other self-service systems would therefore constitute a significant contribution to the art of call center operation.

### OBJECTS AND SUMMARY OF THE INVENTION

It is therefore a principal object of the present invention to enhance the call center operation art by providing a method with enhanced capabilities.

It is another object to provide such a method wherein enhanced operational capabilities are possible.

It is a further object to provide such a method which is readily adaptable for widespread use.

It is yet another object to provide a system which can readily operate in such a manner.

These and other objects are attained in accordance with one embodiment of the present invention wherein there is provided a call center process, comprising the steps of providing content by owners at web sites for customer self-service, capturing customer transaction data during calls to a call center, performing gap analysis of the transaction data, performing a customer value monitor survey, providing the gap analysis and the value monitor survey to the owners to create improved content, installing the improved content at the web sites, and thereafter reviewing customer transaction data during calls to determine reduced call volumes.

In accordance with another embodiment of the invention there is provided a system for call center processing, the system comprising a plurality of web sites created by web content owners, the sites having content for customer self-service, a knowledgebase tool for capturing customer transaction data during calls to a call center, means for performing gap analysis of the transaction data, means for performing a customer value monitor survey, means for providing the gap analysis and the value monitor survey to the owners to create improved content, and means for installing the improved content at the web sites to provide a closed feedback path within the system.

In accordance with yet another embodiment of the invention there is provided a method of providing call center operation capability to a client, comprising the steps of delivering to the client a means for providing content by owners at web sites for customer self-service, delivering to the client a means for capturing customer transaction data during calls to a call center, delivering to the client a means for performing gap analysis of the transaction data, delivering to the client a means for performing a customer value monitor survey, delivering to the client a means for providing the gap analysis and the value monitor survey to the owners to create improved content, delivering to the client a means for installing the improved content at the web sites, and delivering to the client a means for thereafter reviewing customer transaction data during calls to determine reduced call volumes.

### BRIEF DESCRIPTION OF THE DRAWINGS

FIG. 1 depicts the closed loop process of the present invention;

FIG. 2 illustrates in more detail various steps of the present invention; and

FIGS. 3A and 3B are a detailed flowchart of the feedback process.

### BEST MODE FOR CARRYING OUT THE INVENTION

For a better understanding of the present invention together with other and further objects, advantages, and capabilities thereof, reference is made to the following disclosure and the appended claims in connection with the above-described drawings.

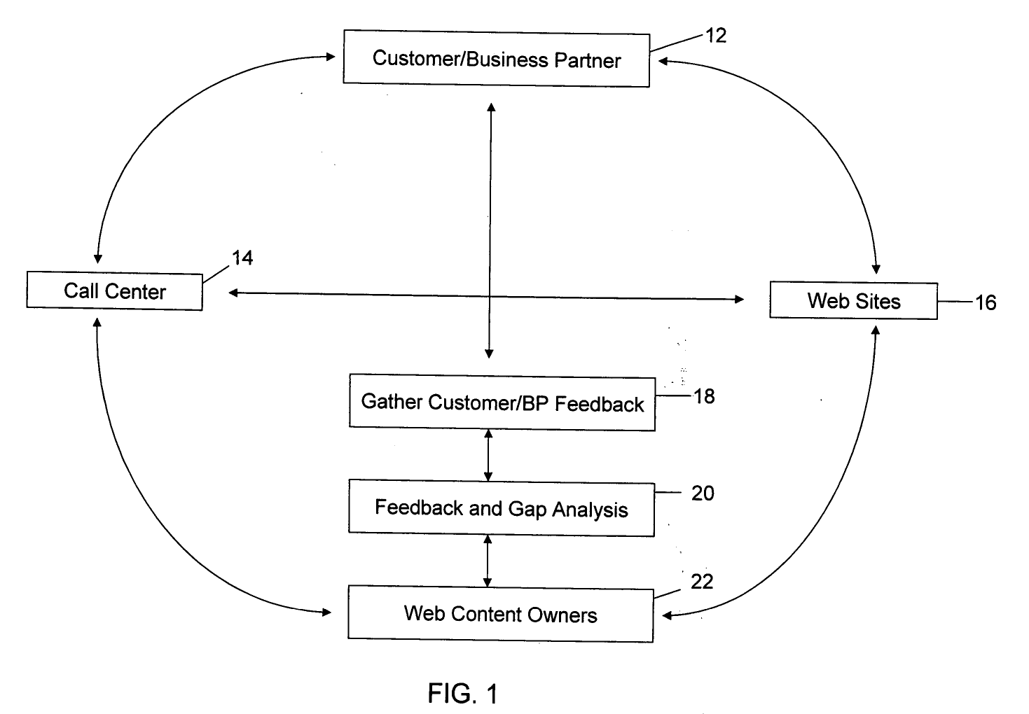

In FIG. 1 there is shown a closed loop feedback path for a call center processing system in accordance with the present invention. Call center 14 receives calls from customers or business partners 12 and performs various transactions in response to customer requests or inquiries. A knowledgebase tool (not shown) in call center 14 is used during calls to capture data relating to the transaction. Some or all of the data relating to the transaction may be captured by a tracking tool operating within or as part of the knowledgebase tool without departing from the scope of the invention. For example, the customer may be referred to a web site 16. The type of inquiry, web site URL, customer comments regarding the web experience, and details of whether the customer accepted the referral may all be captured. Capturing may be automatic by monitoring keystrokes of the call center agent or through speech recognition technology monitoring of the telephone line. Capturing may also include specific input to the knowledgebase tool by the agent during the call.

The agent may also access web site 16 to determine whether the site has the particular information requested, either before, during, or after referral to customer 12. For example, techniques have been developed for an agent to refer a customer to a web site allowing both to navigate and view simultaneously the same web pages during a call.

Web sites 16 are created by web content owners 22.

The system for call center processing includes a software tool 18 for gathering customer feedback in the form of a customer value monitor survey. Feedback from a customer satisfaction survey or transactional survey may also be gathered by software tool 18.

Software tool 18 may gather survey results by sending a survey and gathering results via e-mail, a web page, instant messaging or any other survey sending and receiving technique known in the art including printing hardcopy and sending in a hardcopy mail system.

Analysis tool 20 includes software for performing a gap analysis of transaction data captured in the knowledgebase tool. If self service is refused or is not available, the gap analysis determines the root cause of this result. An action plan is developed to correct the problem.

Gap analysis and survey data are provided to web content owners 22 to create improved content. This improved content is then installed at web sites 16 completing the closed loop process. The improved content may also be added to the knowledgebase tool. Agents in call center 14 are advised of the improved content and begin to refer customer calls to the improved web sites. Subsequent gap analyses and customer surveys should show a higher level of customer satisfaction, acceptance of referrals, and more positive customer comments. As needed, or to achieve even higher levels of customer satisfaction, the closed loop process may be repeated by providing subsequent gap analyses and customer surveys to web content owners 22 to create even more improved content. The closed loop process may also be performed periodically, e.g. weekly, monthly, quarterly as appropriate.

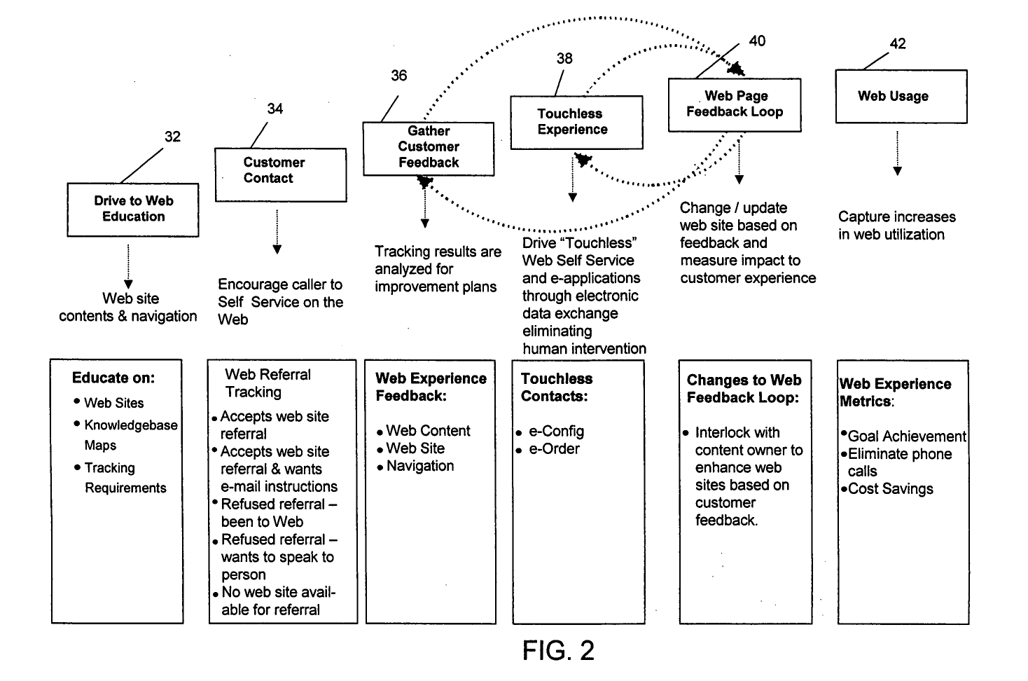

In FIG. 2 there is shown additional detail regarding various steps in a call center process embodiment of the present invention. In step 32, agents in call center 14 are educated about the various web sites 16 which are available. Agents also receive education about the knowledgebase tool such as various maps used for capturing customer transaction data. Agents may also be educated in various tracking requirements which need to be entered during the call.

In step 34 the agent makes a referral to a web site and the customer response is captured.

In step 36 customer feedback is gathered as customer surveys and comments regarding their experience in web content, web sites, and navigation. A gap analysis is also performed on the transaction data captured in step 34.

In step 38, which is optional, various e-applications which do not require contacting a real person are provided. Such applications operate as a data-to-data exchange, resulting in reduced labor hours and therefore overall improved efficiency in the call center operation whenever a caller is referred to one of these.

In step 40 web content owners 22 improve the content based on the gap analysis and customer surveys. The improved (changed) content is installed (update) on appropriate web sites 16. The effect of having improved content is then measured on subsequent gap analyses and customer surveys in steps 40 and 42.

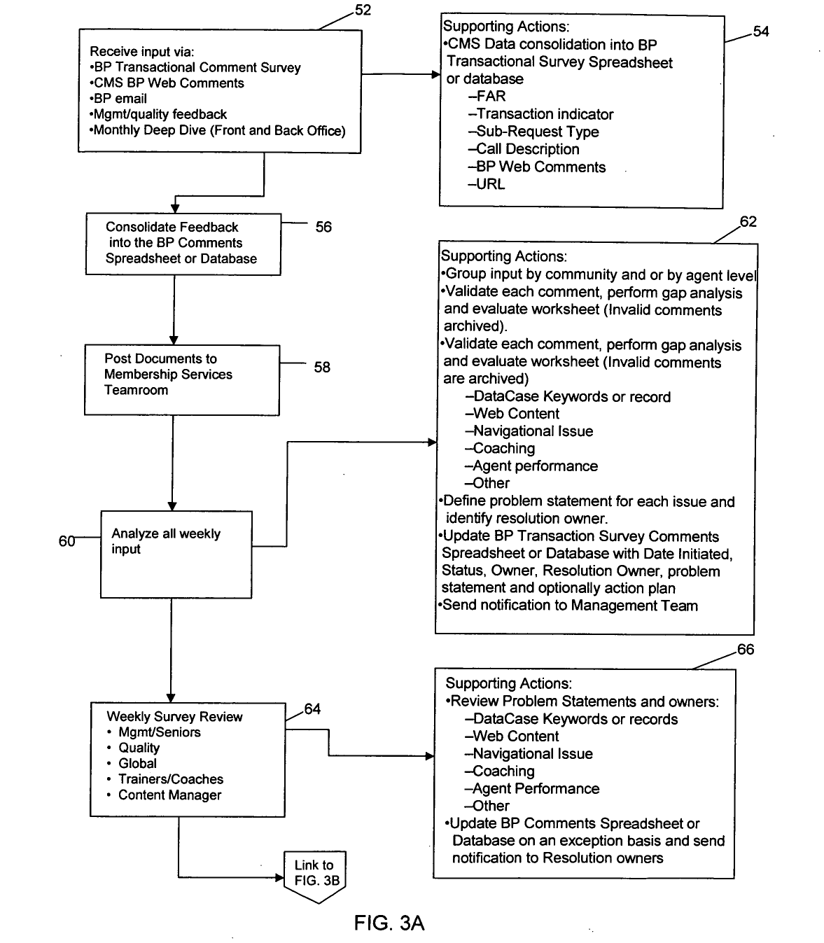

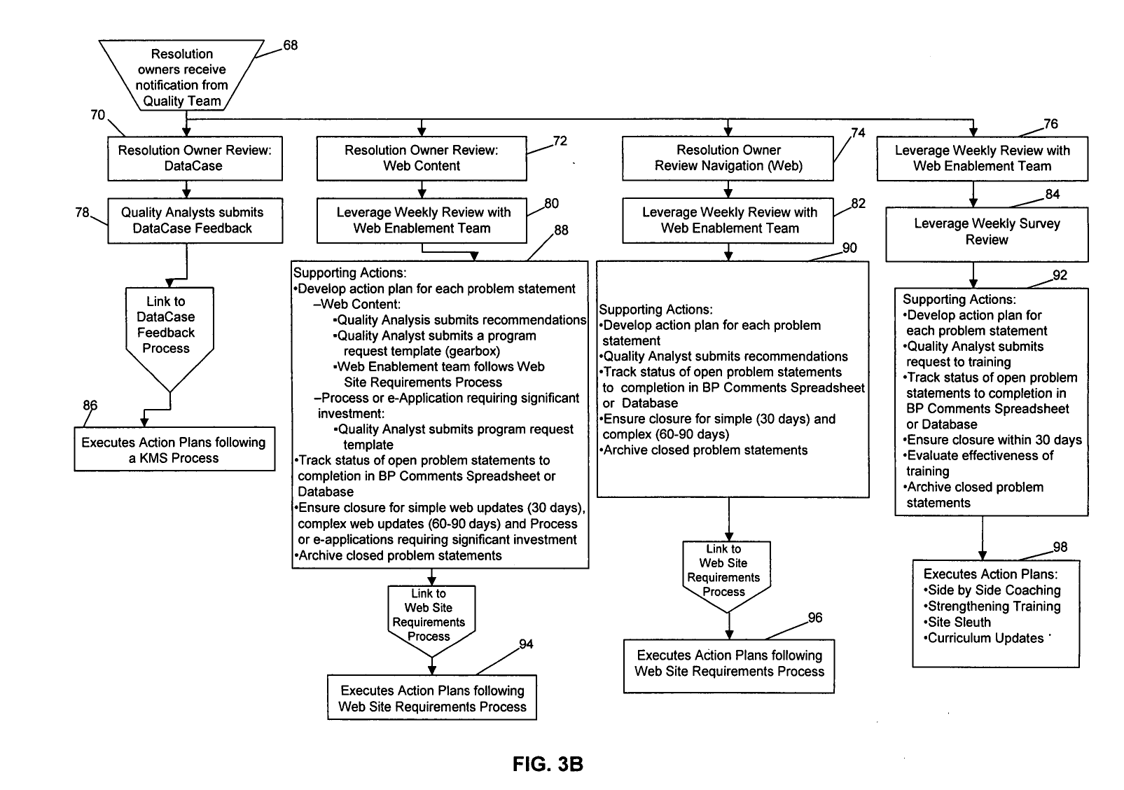

FIGS. 3A and 3B describe in detail a feedback process which may be performed periodically, e.g. weekly, in accordance with the present invention. Feedback input is gathered in step 52 as the business partner (BP) transactional comment survey, a call management system (CMS) BP web comments, BP e-mails, a management (Mgmt) quality feedback survey, and a monthly analysis of front and back office operations. The front office refers to those agents and others directly in contact, such as answering telephones, with callers. Back office refers to supporting staff such as those performing gap analysis, some web site owners, tool developers, agent trainers, and the like.

The feedback is consolidated into a business partner comments spreadsheet or database in step 56 and consolidated into a business partner transactional survey spreadsheet or database in step 54. The data consolidated in step 54 may include first access resolution (FAR) data, a transactional indicator, request and sub-request type, call description, web comments gathered in step 52, and URL to which the customer was referred.

In step 58 the consolidated spreadsheets or database documents are posted to a common repository such as a teamroom for access by call center employees who will be performing gap analysis in step 60. Detailed actions in the analysis are further described in step 62 of FIG. 3A.

In step 64 customer survey data is analyzed. Further details of this analysis are listed in step 66 of FIG. 3A.

Turning now to FIG. 3B, in step 68 web content owners (resolution owners) receive input from the gap analysis and customer surveys. Improvement may be needed in the knowledgebase tool (KMS or DataCase) in steps 70, 78, and 86, or in the web site content in steps 72, 80, 88, and 94, or in the web site design or navigation capability in steps 74, 82, 90, and 96, or in the training or coaching of agents in steps 76, 84, 92, and 98.

While there have been shown and described what are at present considered the preferred embodiments of the invention, it will be obvious to those skilled in the art that various changes and modification may be made therein without departing from the scope of the invention as defined by the appended claims.

1. A call center process, comprising the steps of:
providing content by owners at web sites for customer self-service;
capturing customer transaction data during calls to a call center;
performing gap analysis of said transaction data;
performing a customer value monitor survey;
providing said gap analysis and said value monitor survey to said owners to create improved content;
installing said improved content at said web sites; and
thereafter reviewing customer transaction data during calls to determine reduced call volumes.

2. The process of claim 1, further comprising providing education to said owners of said web sites for customer self-service.

3. The process of claim 2, wherein said education comprises instruction on overall structure and navigation of designs for said web sites.

4. The process of claim 2, wherein said education comprises demonstration on the use of a knowledgebase tool to capture said customer transaction data during a call into a transaction database.

5. The process of claim 1, further comprising performing root cause analysis of instances of said customers not using self-service.

6. The process of claim 5, further comprising determining how to modify behavior of said customers regarding most frequent inquiries.

7. The process of claim 1, further comprising performing results trending of said transaction data.

8. A system for call center processing, said system comprising:
a plurality of web sites created by web content owners, said sites having content for customer self-service;
a knowledgebase tool for capturing customer transaction data during calls to a call center;
means for performing gap analysis of said transaction data;
means for performing a customer value management survey;
means for providing said gap analysis and said value management survey to said owners to create improved content; and
means for installing said improved content at said web sites to provide a closed feedback path within said system.

9. The system of claim 8, further comprising means for performing results trending of said transaction data.

10. A computer program product for instructing a processor to operate a call center, said computer program product comprising:
a computer readable medium;
first program instruction means for providing content by owners at web sites for customer self-service;
second program instruction means for capturing customer transaction data during calls to a call center;
third program instruction means for performing gap analysis of said transaction data;
fourth program instruction means for performing a customer value monitor survey;
fifth program instruction means for providing said gap analysis and said value monitor survey to said owners to create improved content;
sixth program instruction means for installing said improved content at said web sites; and
seventh program instruction means for thereafter reviewing customer transaction data during calls to determine reduced call volumes; and wherein
all said program instruction means are recorded on said medium.

11. The computer program product of claim 10, further comprising program instruction means for performing root cause analysis of instances of said customers not using self-service.

12. The computer program product of claim 11, further comprising program instruction means for determining how to modify behavior of said customers regarding most frequent inquiries.

13. The computer program product of claim 10, further comprising program instruction means for performing results trending of said transaction data.

14. A program storage device readable by a machine, tangibly embodying a program of instructions executable by a machine to perform method steps for:
providing content by owners at web sites for customer self-service;
capturing customer transaction data during calls to a call center;
performing gap analysis of said transaction data;
performing a customer value monitor survey;
providing said gap analysis and said value monitor survey to said owners to create improved content;
installing said improved content at said web sites; and
thereafter reviewing customer transaction data during calls to determine reduced call volumes.

15. The program storage device of claim 14, further comprising a method step for performing root cause analysis of instances of said customers not using self-service.

16. The program storage device of claim 15, further comprising a method step for determining how to modify behavior of said customers regarding most frequent inquiries.

17. The program storage device of claim 14, further comprising a method step for performing results trending of said transaction data.

18. A method of providing call center operation capability to a client, comprising the steps of:
delivering to said client a means for providing content by owners at web sites for customer self-service;
delivering to said client a means for capturing customer transaction data during calls to a call center;
delivering to said client a means for performing gap analysis of said transaction data;
delivering to said client a means for performing a customer value monitor survey;
delivering to said client a means for providing said gap analysis and said value monitor survey to said owners to create improved content;
delivering to said client a means for installing said improved content at said web sites; and
delivering to said client a means for thereafter reviewing customer transaction data during calls to determine reduced call volumes.

19. The method of claim 18, further comprising delivering to said client a means for performing root cause analysis of instances of said customers not using self-service.

20. The method of claim 19, further comprising delivering to said client a means for determining how to modify behavior of said customers regarding most frequent inquiries.

21. The method of claim 18, further comprising delivering to said client a means for performing results trending of said transaction data.
